(19) United States
(12) Patent Application Publication
(10) Pub. No.: US 2014/0126779 A1
(43) Pub. Date: May 8, 2014

(54) System for license plate identification in low-quality video

(71) Applicant: Greg Duda, Mesa, AZ (US)

(72) Inventor: Greg Duda, Mesa, AZ (US)

(21) Appl. No.: 13/668,269

(22) Filed: Nov. 3, 2012

(51) Int. Cl. G06K 9/00

(52) U.S. Cl. 382/105

(57) ABSTRACT

This invention proposes an identification system for license plates captured in low-quality motion video, such as accidental footage from security cameras, amateur video, cell phones, etc, including situations when the license plate number is completely unreadable. This is done by dividing the surface of the license plate into a pattern of segments assigned to a number of groups, each group possessing unique optical properties such as shading, reflectivity, IR absorption, etc. Taking advantage of the the varied light response among the segment groups, the pattern can encode identifying information, e.g. a binary sequence, which helps identify the vehicle. Using image processing software, this information can be decoded from low-quality video footage via an analysis of temporally correlated luminance levels. The system thus allows the identification of vehicles captured accidentally and under poor lighting conditions, as in the case of a security camera in a convenience store capturing the image of a vehicle fleeing a nearby crime scene.

### CROSS-REFERENCE TO RELATED APPLICATIONS

Not applicable

### FEDERALLY SPONSORED RESEARCH

Not applicable

### SEQUENCE LISTING OR PROGRAM

Not applicable

### BACKGROUND

1. Field

This invention presents a solution to license plates identification in low-quality video. It proposes a system of encoding identifying information in the optical properties of a license plate's surface, such as its shading, reflectivity, etc. The decoding of this information with image processing software may help identify vehicles captured on low-quality video, even if the license plate number is unreadable.

2. Prior Art

Many systems exist for identification of human-readable license plates numbers via image processing, such as: UK patent GB 2246894; U.S. Pat. No. 4,567,609 to Metcalf, U.S. Pat. No. 4,878,248 to Jia-Ming Shyu et al, and U.S. Pat. No. 4,817,166 to Gonzalez and Herrera. They have also been described in technical literature: “Automated License Plate Reading” by L. Howington, published in Advanced Imaging, September 1989; “Character recognition in Scene Images”, by A. Shio, Proceedings of AUTOFACT '89, Detroit, Michigan, 1989.

All systems of this kind require cameras installed deliberately for this purpose in specific locations, be it toll booths, parking lots, border crossings, traffic cameras, etc. Such systems do not address the issue of identifying license plates in video coming from third-party, non-deliberate sources, which may have captured a car of interest by accident. Such sources include security and ATM cameras, amateur video, cell phones, or even police car cameras which may have captured some relevant footage, but without enough detail to decipher the license plate. A typical example would be the capture of a vehicle fleeing a crime scene by a security camera in a nearby convenience store, i.e., a camera whose actual purpose is the prevention of shoplifting. The problem with such accidental video is that it is typically of low-quality and, by its nature, not targeted at the car of interest. The car may be only visible in a distance, at the edge of the frame, in shadows etc. The need to identify vehicles in such low-quality video is routine in forensic, law-enforcement or surveillance operations.

To overcome these concerns, this invention proposes a system for encoding identifying information on a license plate in a way that allows recovery even from low-quality video footage, when the text on the license plate is beyond recognition. The proposed identifying information need not be related in any way to the human-readable license plate number. It may be an entirely separate identifying code, such as a digital checksum, etc.

There have been systems proposed for encoding non-textual information on a license plate, but none is able, nor designed, to achieve the above goal of license plate identification in low-quality video. U.S. Pat. No. 6,832,728 by Kennedy proposes a barcode embedded in a license plate, but this method requires the installation of a custom, high-resolution barcode reader and illumination set up specifically for this purpose. U.S. Pat. No. 8,158,252 B2 to Süssner describes a stamping film for license plates with an embedded nano-scale hologram which may incorporate a small text or a logo; however, this hologram is designed as an anti-tampering feature only. It can only be examined from a very close distance and is of no use for identifying vehicles in motion video. Furthermore, the purpose of a hologram is to verify authenticity, not to carry identifying information. Adding unique information to individual holograms would add high cost to what is already an expensive manufacturing process.

### SUMMARY

Described herein is a system for identifying license plates in low-quality video from accidental, third-party sources, such as security or ATM cameras. The system can recover identifying information even if the license plate number is not readable. The system uses a segmented pattern covering the plate's surface. These segments are differentiated by their optical properties, such as surface texture, reflectivity, etc, so that their varied response to light can encode information. This information can be retrieved from the video footage by means of image processing software.

### DRAWINGS

FIG. 1a is a perspective view of a license plate with the proposed segmented surface pattern.

FIG. 1b is a corresponding visual representation of the information encoded in the segmented pattern, in this case a binary sequence: “10101101”.

FIG. 2a is a very low-resolution still frame showing a license plate with no legible characters.

FIG. 2b shows an analysis grid applied in an image processing software to decode the identifying information in the above still frame.

FIG. 3a is a graph showing luminance levels over time, as sampled by the analysis grid.

FIG. 3b is close-up of the above graph showing clusters of luminance levels exhibiting analogous or parallel behavior.

FIG. 4 shows the recovered identifying information, reconstructed by the analysis grid.

FIGS. 5a and 5b show examples of textured license plate surface designed to work with the system.

### DETAILED DESCRIPTION

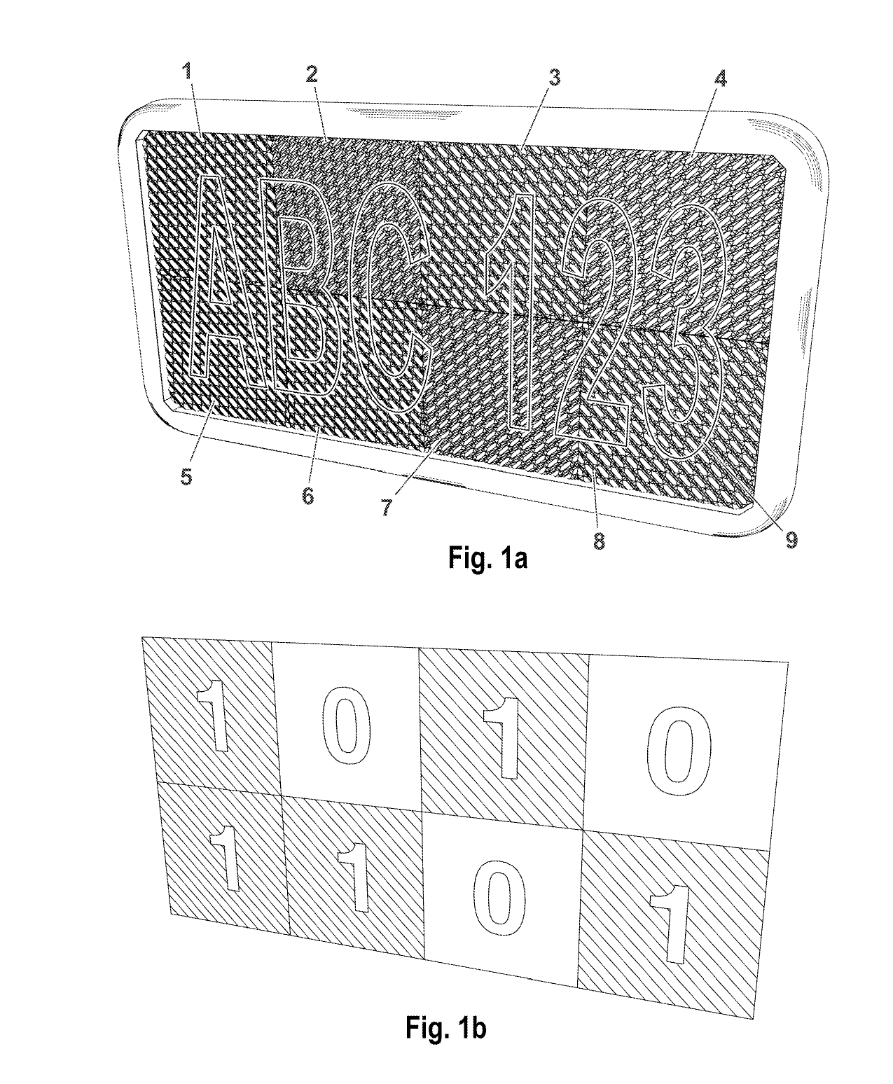

The basic idea behind this invention is to encode identifying information in a segmented light-response pattern (LRP) that covers a license plate's surface. FIG. 1a shows one possible embodiment, in which the LRP is a horizontal, 4×2 grid made of eight square segments 1 through 8, each segment assigned to one of two separate groups. Segments 1, 3, 5, 6 and 8 belong to group 1, segments 2, 4 and 7 belong to group 2. The segments have a textured surface, made of a mesh of small, angled facets, oriented either 45° to the right or to the left of the vertical, depending on which group a particular segment belongs to. Such texture has a substantial directional dependence: its shading is highly attuned to the angle of incidence of the light falling onto it. The texture yields different degrees of shading across the license plate's surface as the car moves and changes its orientation to nearby light sources.

The response to light of a particular segment at a particular moment is not important. What is important is the temporal correlation in light response for all segments within a particular group. As the car moves, each segment responds to light in “sync” with other segments within the same group, but differently from segments in another group (or groups). This effect is enhanced if the vehicle is moving quickly with respect to multiple, nearby light sources, e.g. street lights in nighttime, due to higher frequency of change. This visually differentiable grouping allows the encoding of information. Each segment group can now be assigned a value suitable for a given encoding system, for example, one of the two values “0” and “1” for binary coding.

The human-readable license plate number 9 is shown in outline only, as it is independent and separate from the information encoded in the LRP. The information encoded in the LRP need not bear any relation to the readable license plate number.

The surface texture in FIG. 1a is not shown to scale, merely to exhibit its essential features. The actual scale of the facets, in any of the three dimensions, may be of any degree sufficient to produce varied response to light when the plate is viewed from a substantial distance, that is a distance from which the license plate number becomes illegible.

The faceted surface texture is just one possible embodiment of the invention. Other embodiments may use other optical properties to produce varying light response across the LRP: reflectivity, IR absorption, etc, or a combination thereof. Similarly, the binary coding is just one possible method of encoding information in the LRP. Other methods can be used, including methods with more than two differentiable groups.

FIG. 1b shows a visual representation of the information encoded by the LRP in FIG. 1a. In the shown example, the information is an 8-bit binary sequence, in which each bit, either “0” or “1”, corresponds to a segment textured in one of two possible ways (two possible ways are required for base-2 or binary code). The shown sequence reads “10101101”, left to right, top to bottom.

### Operation

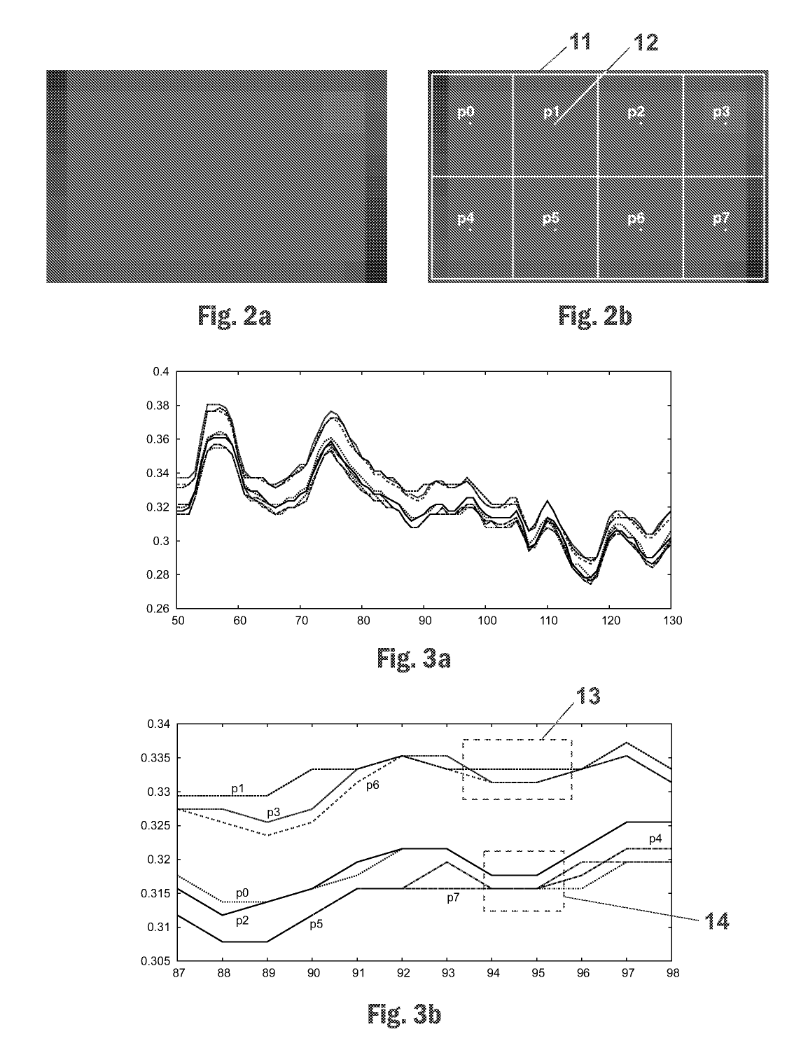

To recover the encoded information, a video sequence showing the car of interest is fed into image processing (IP) software. FIG. 2a shows a single frame from such a sequence, cropped to show just the license plate. A license plate typically occupies a very small portion of the frame. In this low-quality video the size of the cropped image is just 16×10 pixels. In a still image of such low resolution, not only is the license plate number completely unreadable, but even the LRP cannot be made out. For information to be decoded successfully, the image resolution, in theory, can be as low as the Nyquist limit, which for a 4×2 grid would be 8×4 pixels.

In FIG. 2b, an analysis grid 11 is laid over the image of the license plate in the IP software. Grid 11 tracks the location of the license plate in the motion video, so that its corners register with the corners of the license plate in each frame. The grid is subdivided into segments corresponding geometrically to the LPR known to be present on the plate, in this case a 4×2 grid. At the center of each grid segment is a sampling point 12. Each sampling point reads the luminance value from the underlying image. The sampling process may use raster interpolation and noise reduction techniques to its advantage. The result is plotted on a graph over time.

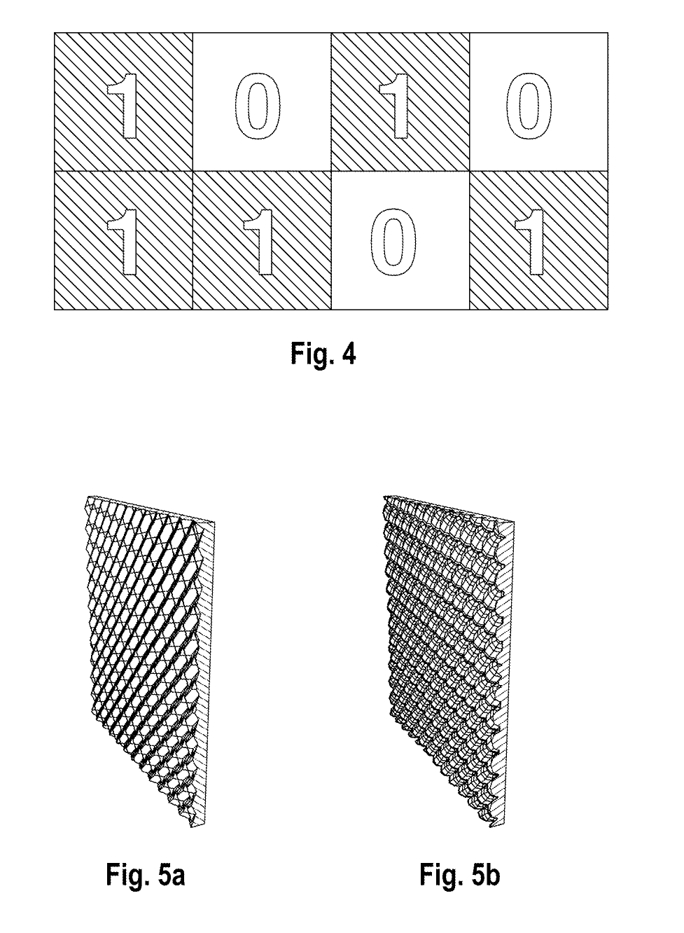

FIG. 3a shows a luminance graph for the entire video sequence for all sampling points. FIG. 3b shows a close-up of this graph, with each line labeled with the index of the corresponding sampling point. In FIG. 3b it becomes obvious that the sampled luminance levels cluster in two groups 13 and 14, the levels within each group having analogous or parallel response to light. In this case, group 13 contains points p1, p3, p6; group 14 contains points p0, p2, p4, p5, p7. The binary value of “0” can now be assigned to points in group 13, and the binary value of “1” to points in group 14. By transposing these binary values onto their respective locations in the analysis grid, the original binary information in the LRP can now be recovered, as shown in FIG. 4. If clustering in the luminance graph is less apparent, analytical methods may be used to determine the correlation between the levels and thus extract the grouping information.

There is an inherent trade-off between how simple the LRP is and how much information it can convey. The simpler the LRP is, the easier it is to decode under adverse conditions, but the shorter the sequence it can contain. For this reason, the sequence encoded in the LRP does not have to identify the car uniquely by itself. It can rely on a compromise between reliability and the degree of identification it provides. For example, the sequence can be a digital checksum assigned to cars of a particular make, model, color or other readily identifiable features. Thus a relatively short checksum can be used to identify the car in conjunction with such characteristics, which are usually apparent even in low-quality video. In this approach, the checksums would be distributed across car makes, models, etc, so as to maximize their identification capability. The overall objective is to extract as much reliable identification as possible. Even if full identification cannot be attained, some degree of identification will help narrow the search range. Thus the proposed system occupies the “middle ground” between situations where just the silhouette of a car be made out in a video sequence, and situations when the license plate is readable.

### Ramifications

FIGS. 5a and 5b show some, but not all, possible types of textured surfaces with the desired directional light response. FIG. 5a shows flat, hexagonal facets, while FIG. 5b shows half-cylindrical beads in staggered, parallel rows. In each case the textured surface yields shading highly dependent on the angle of incidence of the light falling onto it. The manufacturing of such a texture can be accomplished in many ways: mechanical stamping of the license plate itself, gluing a textured mesh onto the plate's surface as an overlay, applying adhesive sheeting with an internal structure of angled facets or beads already embedded in the sheeting, etc.

It should be recognized that a faceted texture is but one of many ways of varying light response between segment groups. Other methods include: variance in reflectivity achieved by covering the segment groups with materials of different reflectivity; variance in IR absorption achieved by defining the groups with IR absorption filters, etc.

### Conclusion

The proposed invention offers these advantages:

(a) Unlike the prior art, it can recover information identifying a vehicle from low-quality video, even if the license plate number is completely unreadable.

(b) In theory, it can work with license plate images just several pixels in size.

(c) It does not depend on cameras installed in locations known in advance; instead, it is designed to work with third-party, accidental video footage.

(d) It addresses an existing, routine need in forensic, law-enforcement and surveillance fields, hitherto not addressed by prior art.

(e) It presents a low cost solution, since adhesive sheeting with described properties can be applied to existing license plates.

I claim:

1. A license plate identification system wherein the surface of the license plate is divided into a plurality of segments, said segments assigned to a plurality of groups, each of said groups having a distinct response to light by means of optical properties such as shading, reflectivity, refraction, absorption or other properties, said light response being substantially uniform within a particular group, yet varied between groups, said segments arranged to encode information that aids in identifying the license plate.
(a) A license plate identification system of claim 1 wherein the segmented pattern is a 4×2 horizontal grid.
(b) A license plate identification system of claim 1 wherein the encoding is binary.
(c) A license plate identification system of claim 1 wherein the encoded information is a checksum assigned to vehicles of a particular make, model, color and/or other visually apparent features, said checksums distributed among vehicles so as to maximize their identification capability in conjunction with said apparent features.

2. A software method designed to decode information from a license plate described in claim 1, said software method using a pattern of analysis points, their locations corresponding geometrically to the encoded pattern on said license plate, said analysis points used to sample a motion-tracked image of the license plate and recover luminance levels from corresponding image locations, said luminance levels recorded over time and analyzed to find clusters of locations exhibiting substantially analogous or synchronized behavior, said locations assigned values in accordance with the encoding system known to be present on the license plate, said values then arranged in a sequence to recover the identifying information.
(a) A software method of claim 2 wherein the analysis pattern is a 4×2 horizontal grid.
(b) A software method of claim 2 wherein the sampling process uses raster interpolation and noise reduction techniques to improve the sampling results.
